(19) United States
(12) Patent Application Publication
(10) Pub. No.: US 2008/0041122 A1
(43) Pub. Date: Feb. 21, 2008

(54) WELLHEAD SECURITY SYSTEM

(76) Inventor: Earl Gordon, Rimbey (CA)

Correspondence Address: PARLEE MCLAWS LLP, 1500 MANULIFE PLACE, 10180-101 STREET, EDMONTON, AB, T5J 4K1, US

(21) Appl. No.: 11/625,308

(22) Filed: Jan. 20, 2007

(30) Foreign Application Priority Data
Jun. 20, 2006 (CA) 2550793
Aug. 9, 2006 (CA) 2555668

(51) Int. Cl. G05G 5/00; E05B 67/00

(52) U.S. Cl. 70/20; 70/174; 70/19

(57) ABSTRACT

A system for restricting access to wellhead equipment is provided. A cable may be snugly wrapped around or threaded through wellhead equipment and secured with a cable restraint to prevent loosening of the cable from the equipment. Other devices are also provided within the system, the devices for covering ports or shielding equipment to prevent unauthorized access to the ports and/or equipment. Such devices may also be secured with the cable and restraint system. A method and kit for securing wellhead equipment are also provided.

### FIELD OF THE INVENTION

The present invention relates generally to devices that may be affixed to a wellhead. More particularly, the present invention relates to security devices and a security system for locking a wellhead to deter unauthorized access to the wellhead.

### BACKGROUND OF THE INVENTION

As exploration for new oil and gas reserves has grown increasingly more competitive, companies have developed various intelligence strategies to obtain proprietary information regarding their competitors' production capabilities, strategies, and potential locations for exploration. In certain jurisdictions, legislation may provide a limited period of confidentiality to oil companies drilling exploratory wells. Such confidential information may be invaluable to a competitor, particularly when an exploratory well is located adjacent to saleable and/or unproven land. Covertly obtaining favourable information regarding the exploratory well of a competitor may allow the adjacent land to be purchased simply by outbidding the unsuspecting company who drilled the exploratory well.

Despite attempts by oil companies to maintain the confidentiality of their exploratory and active wellhead information, oil well scouts are frequently contracted by competitive oil companies to obtain intelligence regarding these wells. Requests for information may include wellhead pressure measurements, daily depths, penetration rates, formation pressures, drilling mud properties, flow pressures, gas flow rates, perforation intervals, and production potential estimates. Oil scouts obtain this information using many techniques, often including trespassing on company property by night and taking readings directly from the wellhead of interest.

When securing a wellhead, site engineers who are wary of scouting activity may remove the pressure gauges from the wellhead and replace them with threaded plugs to prevent scouts from simply reading and recording wellhead pressures therefrom. Scouts therefore carry a variety of tools and equipment, and may easily remove a threaded plug from an open port and insert a pressure gauge to take the desired reading.

Such trespassing by oilfield scouts not only causes companies to lose their competitive edge, but exposes the company to liability if the integrity of the wellhead is breached and a leak occurs. In addition, vandals have been known to tamper with wellheads, which may release sour gas into the atmosphere. The potential for release of sour gas from an oil or gas well poses a great hazard to oilfield personnel, particularly if the well is not properly secured and monitored. Thus, when exploring and flow-testing well sites that may potentially produce sour gas, some oil companies have eliminated the practice of providing on-site sleeping quarters for their site engineers, choosing instead to provide off-lease sleeping quarters. This creates an even greater need to provide adequate physical security measures on these unsupervised leases.

Oil companies have employed rudimentary measures such as chains and padlocks to secure their wellhead equipment from theft and to deter oil scouts and vandals, however these measures are easily circumvented simply by cutting a link in the chain to remove the chain and padlock from the wellhead. If the chain is removed from the wellhead, information may be gathered and the chain reconnected, leaving minimal evidence of tampering. Moreover, even when the wellhead master valve is secured with chains, scouts may remove the nut holding the master valve in place, lift off the master valve with the chain still intact, open the valve, unscrew the bull plug, and screw in their own pressure gauge to obtain pressure measurements. Thus, chains and padlocks do not sufficiently prevent information theft. In fact, such rudimentary measures may cause more serious problems for the company owning the wellhead if such tampering causes a leak, as the leak would appear to be caused by the company's own personnel if evidence of tampering is not apparent. As such, current methods for securing wellheads do not deter tampering or information theft, and do not provide adequate security to oil companies.

It is, therefore, desirable to provide a device and system for securing wellheads to prevent theft of proprietary information.

It is further desirable to secure wellheads in a manner that deters oil scouts from tampering.

### SUMMARY OF THE INVENTION

In a first aspect of the invention, there is provided a system for securing wellhead equipment at a wellhead, the system comprising a length of cable for wrapping or threading through wellhead equipment; a cable restraint including two opposing clamping members for reversibly clamping the cable; and a locking mechanism for locking the clamping members in a clamping position around the cable to secure the cable around the wellhead equipment.

In a second aspect of the invention, there is provided a system for securing wellhead equipment at a wellhead, the system comprising a length of cable for wrapping around wellhead equipment, the cable having a series of enlarged regions along its length; a cable restraint for closing around a portion of the cable to secure the cable around the wellhead equipment, the cable restraint formed from two opposing clamping members; and a locking mechanism for locking the clamping members in closed position around the cable to prevent sliding of the cable restraint past an enlarged portion of the cable.

In an embodiment, the cable is steel rope, and the enlarged portions of the cable may be formed by threading steel cylinders onto the cable and crimping the steel cylinders in place against the cable.

In a further embodiment, the opposing clamping members are hingedly connected to facilitate closing around the cable. The clamping surfaces of the clamping members may directly clamp the cable to secure the position of the cable, or may be notched to accommodate moderate sliding of the cable while preventing sliding of the cable past an enlarged portion of the cable.

In one embodiment, the locking system comprises a padlock for insertion through aligned apertures in the clamping members when the clamping members are closed around the cable.

The system may further comprise one or more device shields for limiting access to one or more wellhead devices, each shield having a cable guide through which the cable may be threaded to secure the shield against the respective device.

In an embodiment, the shield further includes a threaded portion for fastening into an open port on the wellhead to shield the port, and wherein removal of the threaded portion from the port may be prevented by securing the shield with the cable.

In another embodiment, the device shield includes a housing for placement over the device to obscure the device when the shield is secured with the cable against the device. For example, the device may be a pressure gauge, over which the housing is placed to obscure the gauge. The housing may further include a lockable access door through which the pressure gauge may be accessed without removing the device shield.

In a third aspect, the invention provides a wellhead device shield for engaging a wellhead device to limit access to the device, the shield having a cable guide through which a cable may be threaded to secure the shield against the device.

In an embodiment, the shield further includes a threaded portion for fastening into an open port on the wellhead to cover the port and thereby prevent unauthorized access to the port.

In another embodiment, the shield includes a body for placement over a pressure gauge to prevent unauthorized individuals from viewing the pressure gauge. The body may include a lockable access door to permit reading of the pressure gauge without removal of the body from the pressure gauge.

In a fourth aspect of the invention, a method for securing wellhead equipment is provided, the method comprising the steps of: providing a length of cable having a series of enlarged regions along its length; wrapping the cable around the wellhead equipment; providing a cable restraint formed from two opposing clamping members for closing around a length of the cable, and a locking system for locking the clamping members in a closed position around the cable; closing the restraint around the cable proximal to an enlarged portion of the cable so as to prevent loosening of the cable from the wellhead equipment; and locking the restraint in closed position. The clamping surfaces of the clamping members may be notched to allow minimal sliding of the cable between the clamping members, such sliding limited by the presence of the enlarged portions of the cable.

In an embodiment, the method further comprises the steps of: providing a shield for engaging a wellhead device, the shield having a cable guide through which a length of cable may be threaded; engaging the wellhead device with the shield; and threading the cable through the cable guide in the shield prior to securing the cable with the restraint around the wellhead.

The shield may further include a threaded portion for fastening into a wellhead port prior to securing the shield with the cable. Further, the shield may include a housing for shielding a pressure gauge to prevent unauthorized individuals from viewing the pressure gauge.

A further aspect of the invention provides a kit for use in securing wellhead equipment, the kit comprising a length of flexible cable for wrapping around wellhead equipment; a cable restraint for closing around the cable to secure the cable against the wellhead equipment; and a locking system for use in locking the restraint around the cable to secure the cable against the wellhead equipment, thereby preventing removal of the equipment from the wellhead.

In one embodiment, the kit further comprises two or more steel cylinders for affixing to the cable to enlarge the diameter of the cable at two or more locations adjacent the cable restraint to prevent loosening of the cable from the wellhead equipment. The kit may also include one or more device shields for engaging a wellhead device, each shield having a cable guide such that the device shields may be secured to the wellhead device with the cable and restraint.

### BRIEF DESCRIPTION OF THE DRAWINGS

Embodiments of the present invention will now be described, by way of example only, with reference to the attached Figures, wherein:

FIG. 1 is a schematic of a typical prior art wellhead fitted with wellhead equipment;

FIG. 2 is a schematic of a cable in accordance with an embodiment of an invention;

FIG. 3 is a schematic of a wellhead that has been secured in accordance with an embodiment of the invention;

FIG. 4a is a schematic side view of a cable restraint in accordance with an embodiment of the invention;

FIG. 4b is a schematic side view of a cable restraint in accordance with an embodiment of the invention;

FIG. 4c is a perspective view of a cable restraint in accordance with an embodiment of the invention;

FIG. 5 is a perspective view of a threaded bull plug having a cable guide in accordance with an embodiment of the invention; and

FIG. 6 is a perspective view of a pressure gauge cover in accordance with an embodiment of the invention.

### DETAILED DESCRIPTION

Generally, the present invention provides a system for securing oil and gas wellheads to prevent tampering and information theft.

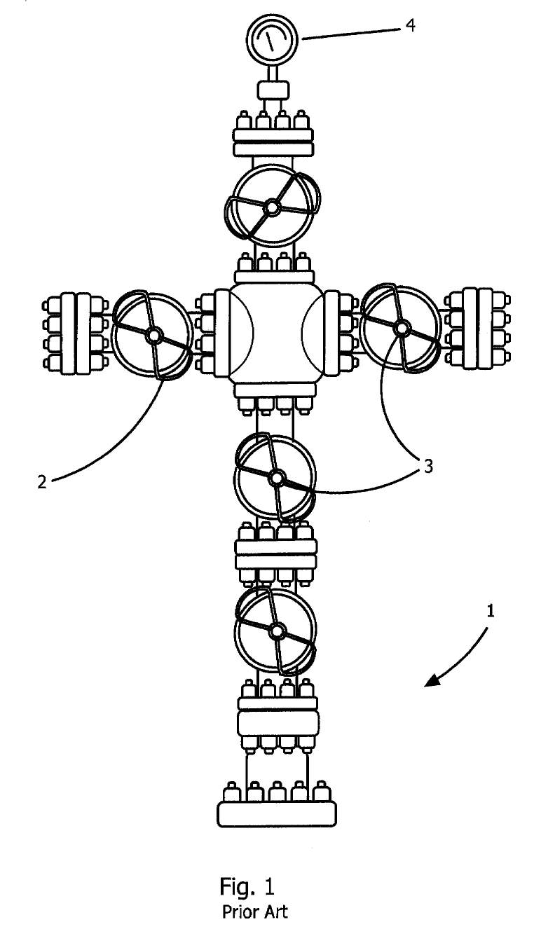

FIG. 1 shows a schematic drawing of a wellhead 1 fitted with typical wellhead equipment, including valves 2, bull plugs 3, and pressure gauge 4. When such equipment is fitted to a wellhead, any person may generally approach the wellhead and view or manipulate the equipment. As wellheads are often located in remote areas, such trespassing and tampering with wellhead equipment may be undetectable by the land or equipment owner.

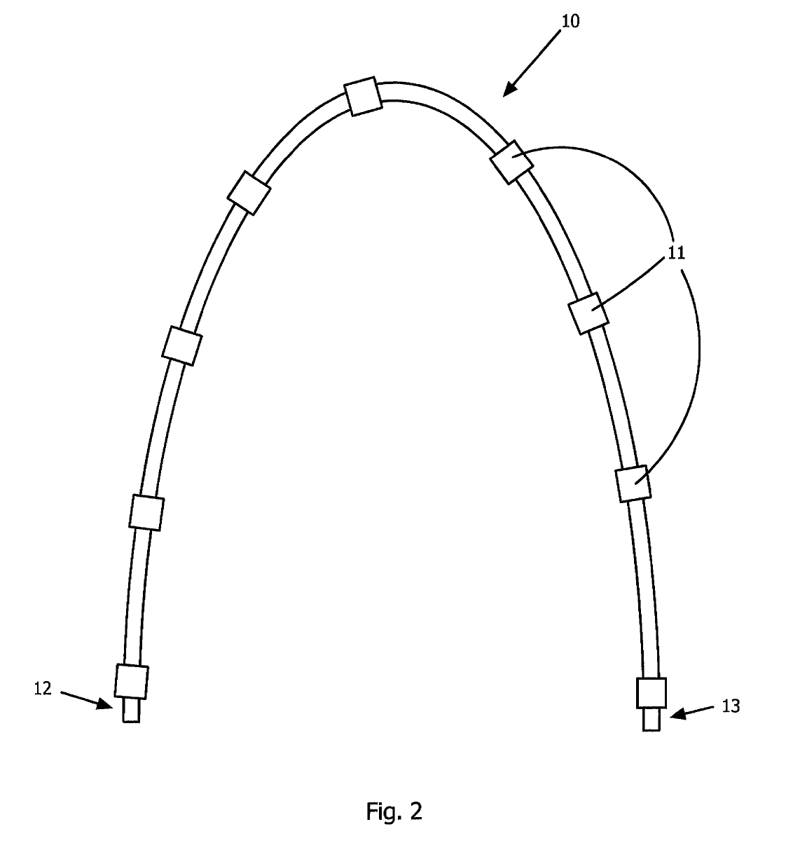

As shown in FIG. 2, a flexible steel cable 10 is provided in accordance with an embodiment of the invention for use in securing wellhead equipment. The cable 10 includes enlarged cylindrical portions 11 at certain locations along its length. The enlarged portions may be present near the ends 12, 13 of the cable, or may be spaced along the entire length of the cable. The cable 10 is generally intended for wrapping around wellhead equipment and/or threading through wellhead equipment to securely fasten it in position. For example, the cable may be wound through/around valve wheels to prevent opening of the valves at the wellhead. The ends 12, 13 of the cable are secured in accordance with the invention to prevent unauthorized access to or tampering with the equipment.

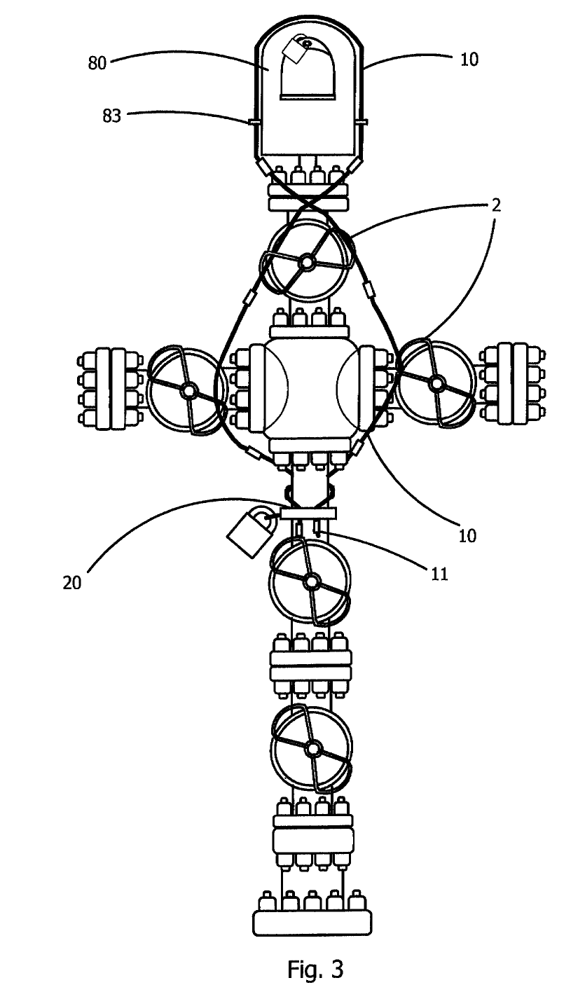

FIG. 3 shows a wellhead that has been secured in accordance with an embodiment of the invention. Cable 10 has been wrapped around and through the wellhead equipment, and a cable restraint 20 has been locked around cable 10 adjacent to enlarged portions 11 of the cable 10 to ensure the cable 10 cannot be loosened or removed from the equipment. When locked, the restraint may be moved minimally along the cable until a surface of the restraint abuts an enlarged portion 11 of the cable 10. Thus, when the cable is wrapped tightly around/through one or more pieces of wellhead equipment, locking the restraint around the cable at a location proximal to an enlarged portion 11 will prevent any significant loosening of the cable from the wellhead equipment. The cable may be generally wound around wellhead equipment, including valve wheels, etc. to secure them and thereby prevent oil scouts or vandals from manipulating same.

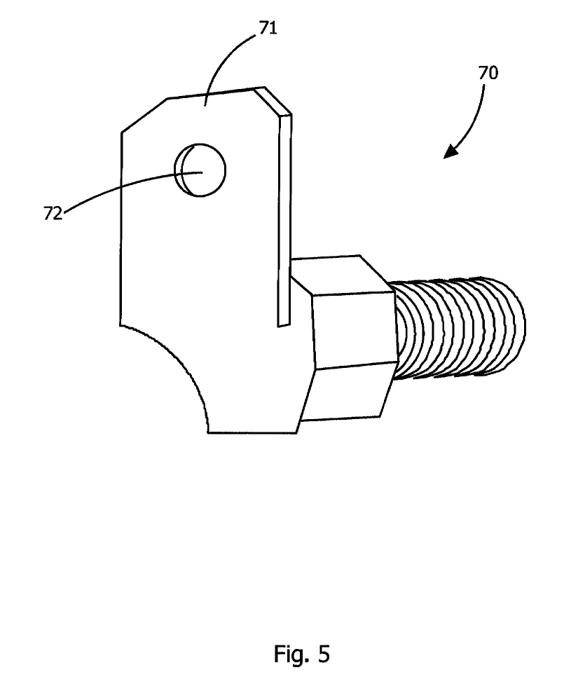

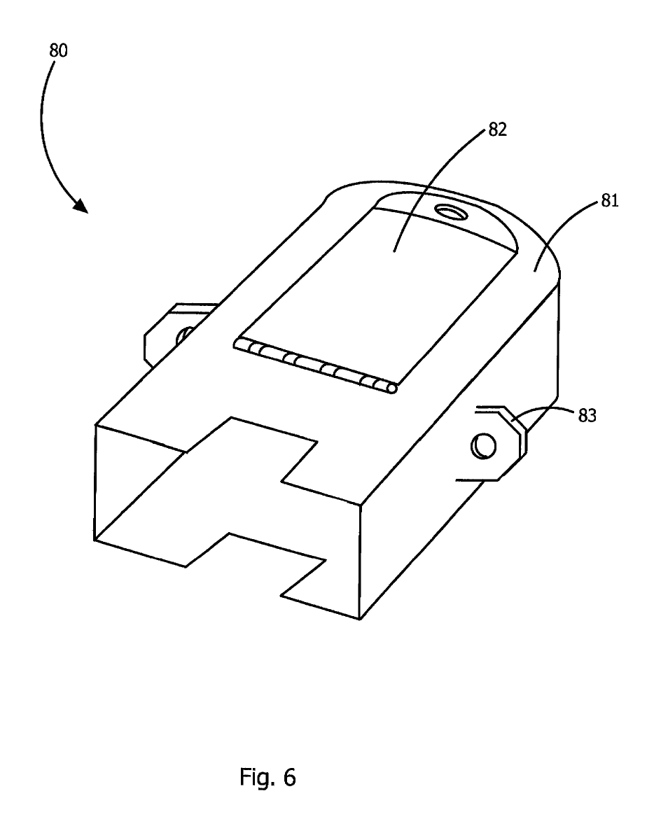

Additional devices that may be used with the above cable 10 and restraint 20 to secure certain types of wellhead equipment are shown in FIGS. 5 and 6.

### Cable

The cable 10 shown in FIG. 1 is preferably composed of steel rope, and the enlarged portions 11 are preferably cylindrical sleeves that have been formed onto the cable or threaded onto the cable and then clamped or crimped in place. When clamped in place, the clamped sleeves substantially maintain their cylindrical exterior shape, while tightly engaging the steel rope such that sliding of the sleeve along the cable is no longer possible. Although a cable containing only two enlarged portions may be adequately secured about wellhead equipment by the cable restraint, it is preferable that the cable include a series of spaced apart enlarged cylindrical portions, as such a configuration provides greater flexibility to the user in securely wrapping the wellhead equipment with the cable, and also permits more than one restraint to be used with one length of cable if locking the position of the cable at more than one location is desirable.

The cable may be provided in various lengths, and may be cut as appropriate for custom fitting to a particular configuration of wellhead equipment. It is also contemplated that the cable may be provided without enlarged portions, and that cylindrical sleeves may be custom-fitted to the cable based on the measurements or requirements of a particular wellhead configuration.

Moreover, in certain embodiments, the cable need not include enlarged portions. In such embodiments, to prevent sliding of the restraint along the cable, and subsequent loosening of the cable from the wellhead equipment, the restraint may simply be a hinged clamping device that is lockable in a clamped position against the cable. The clamping portions of such device may include a serrated surface or teeth for frictionally engaging the cable.

### Restraint

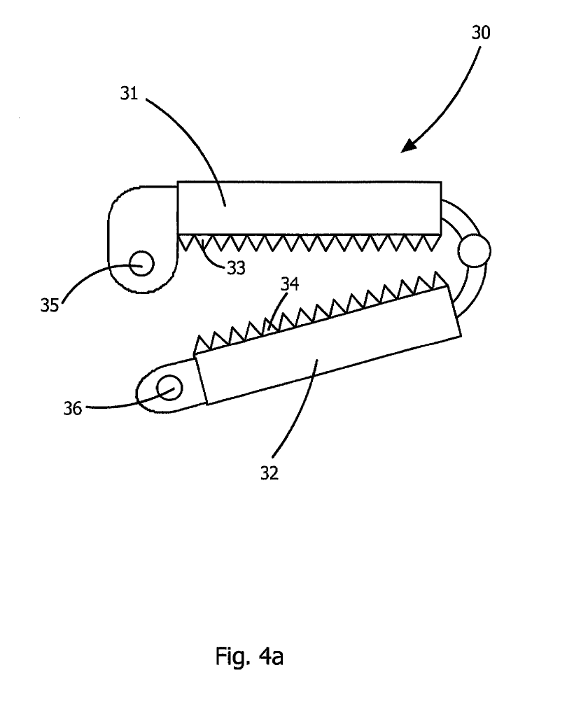

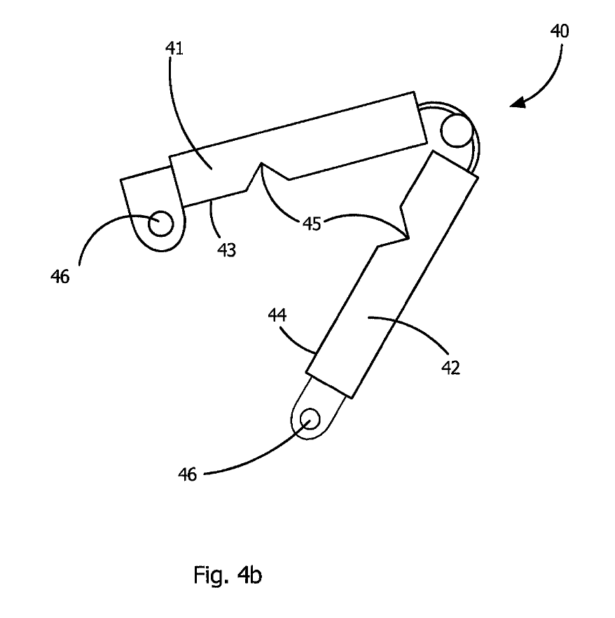

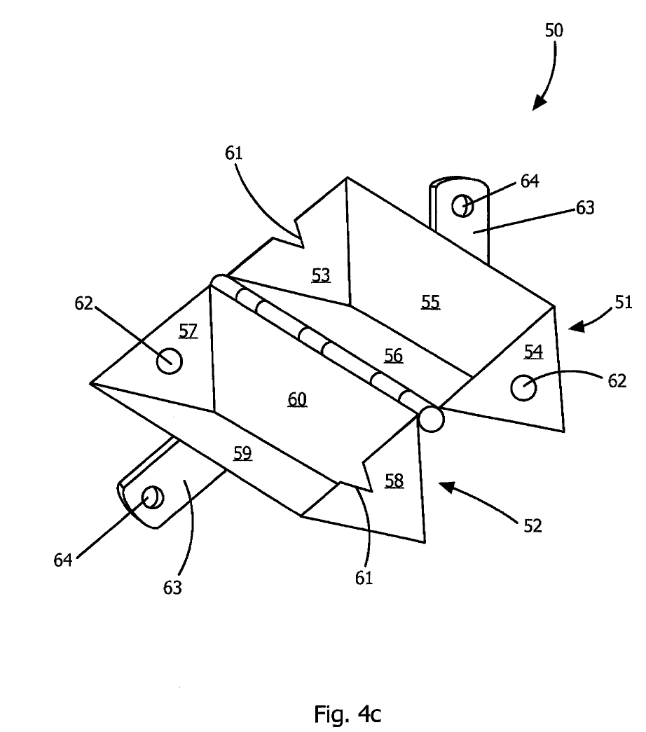

Embodiments of cable restraints for use in accordance with the invention are shown in FIGS. 4a, b, and c. Generally, the restraints are for securing the cable tightly against the wellhead equipment once the cable has been wrapped around the wellhead equipment. The restraints of the present invention will prevent the cable from being loosened, and thereby prevent unauthorized access or tampering at the wellhead.

The restraints of the present invention generally include two opposing clamping members, which are preferably hingedly connected to form a clam-type device for closing around cable 10.

As shown in FIG. 4a, cable restraint 30 includes two opposing clamping members 31, 32 for clamping the cable 10, and the clamping surfaces 33, 34 are roughened to prevent sliding of the cable 10 within the restraint 30. The clamping members may be locked together against the cable 10 by insertion of a padlock through apertures 35, 36 associated with each clamping member.

As shown in FIG. 4b, cable restraint 40 includes two opposing clamping members 41, 42 having clamping surfaces 43, 44, and each clamping surface includes notches 45 to receive a portion of cable 10. The notches 45 are preferably slightly larger than the diameter of the cable, but smaller than the diameter of the enlarged portions of the cable to prevent sliding of the restraint 40 past an enlarged portion 11 of the cable 10. Each clamping member 41, 42 further includes a locking aperture 46 such that when the clamping surfaces of the clamping members are in contact, the apertures 46 align such that a padlock or other locking device may be inserted therewithin for locking the clamping members together.

To use restraint 40 in securing wellhead equipment, cable 10 is snugly wound around or threaded through the wellhead equipment and two adjacent portions of the cable 10 are placed within the notches 45 of clamping surfaces 43, 44. The clamping members are brought together and a padlock is inserted through the locking apertures 46 to lock the restraint around the adjacent portions of cable. It is preferable that the restraint be applied to portions of cable 10 having enlarged portions 11 on either side of the restraint 40 to minimize the ability of a thief or oil scout to loosen of the cable by pulling on the cable 10 or restraint 40.

As shown in FIG. 4c, cable restraint 50 is formed by a diagonally bisected cube, with bisected portions 51, 52 hinged together such that each bisected plane bears a clamping surface when the restraint is closed. Bisected portion 51 is defined by two bisected end walls 53, 54 and two side walls 55, 56. Bisected portion 52 is defined by two bisected end walls 57, 58 and two side walls 59, 60. As shown in FIG. 4c, side walls 56 and 60 are hingedly connected to permit the restraint to close, bringing walls 53, 54, and 55 into contact with walls 57, 58, and 59 respectively.

It is preferable that at least two opposing end walls (for example 53 and 58, as shown) of the restraint bear a notch 61 for receiving a portion of cable, the notches being larger than the diameter of the cable 10 but smaller than the diameter of the enlarged portions 11 of the cable 10. Additional notches or apertures may also be present in the end walls, which may be larger than the enlarged portions. For example, as shown in FIG. 4c, end walls 53 and 58 bear notches 61, while apertures 62 are present in end walls 54 and 57. The apertures 62 are sufficiently large to permit sliding of an enlarged portion 11 of the cable 10 therethrough, however the enlarged portion 11 will not be slidable past the notches 61 when the restraint is closed around the cable 10.

To secure the restraint 50 in closed position around the cable 10 when in use, each bisected portion 51, 52 bears a locking member 63 having a locking aperture 64 through which a padlock or other securing device may be inserted to lock the restraint 50 closed around the cable 10.

Many alternate embodiments of the restraint are possible while still remaining within the spirit and scope of the invention. For example, the restraint generally described above and shown in FIG. 4c may be modified such that notches 61 are present in the clamping surfaces of opposing end walls 53, 54, and 57, 58. Alternatively, a notch may be present in opposing clamping surfaces of only one clamping member, for example in end walls 57, 58. Further still, the notches 61 may be sized to accommodate more than one portion of cable, while still limiting movement of an enlarged portion of the cable past the restraint.

Further, each of the restraints described above serve to secure a portion of cable 10 against sliding or pulling with respect to the restraint by frictionally engaging the cable or by limiting movement of an enlarged portion of the cable 10 past the restraint. A person of skill in the art after considering the above examples may also devise other restraint configurations suitable for use in accordance with the invention.

### Device Shields

Daily removal of certain wellhead devices from the wellhead and replacement with the bull plug described above may be difficult or otherwise undesirable. Moreover, during flow testing, it is desirable to conceal certain gauges or other devices from view even by oilfield personnel. This poses a problem for flow-testers as pressure and flow readings may be required as often as every 30 minutes. Ready access to locked devices and/or gauges is therefore desirable. Accordingly, in an embodiment of the invention, there are provided protective shields that may be fitted over such devices to prevent tampering. Examples of such protective shields are shown in FIGS. 5 and 6.

A bull plug port shield 70 is shown in FIG. 5 for use with the cable and restraint system described above. The port shield 70 bears a cable guide 71 having an aperture 72 larger than the enlarged portion 11 (if present) of the cable 10. The shield 70 may be threaded into any open port that is to be secured by the user. When the shield 70 has been tightly fastened into the port, the cable 10 may be threaded through the aperture, pulled taut, and secured by the restraint. This will prevent the threaded shield from being twisted during attempted removal.

With reference to FIG. 6, a pressure gauge shield 80 is shown having a housing or sleeve 81, an access door 82, and one or more cable guides 83. The pressure gauge shield 80 is placed over a pressure gauge 4 on the wellhead, and a length of cable 10 is passed through each cable guide 83, pulled taut and wrapped around the wellhead, and secured by a restraint 20 and padlock. The access door may also be locked with a separate padlock.

An authorized individual may be granted a key to the access door 82 padlock in order to take periodic pressure readings during flow testing, for example. This user may or may not also be granted access to other device shields, or to cable restraints.

Similar device shields may be developed in which other critical components or measurements may be shielded from view by unauthorized personnel. These device shields may be locked against the wellhead equipment using the cable and restraint system described above.

### Methods to Make Security Devices

The above security devices are preferably formed by welding together pieces of steel. Although it is contemplated that the devices may be custom built on-site, it is generally not recommended to do so as specific regulations are typically imposed upon drilling and production sites to minimize the potential for hazardous occurrences. Generally, devices that may produce significant heat or sparks are therefore not permitted at wellhead locations.

Although the security devices described herein remain subject to removal by an oil scout or vandal by cutting the cable or padlocks, the devices provide a valuable deterrent against oil scouts, as such tampering would be immediately evident to the site engineer on daily inspection of the wellhead, and appropriate security detail could be implemented to prevent further tampering or to apprehend trespassers. Moreover, in the event of an oil or gas leak or explosion, the company owning the wellhead equipment would have evidence to indicate that appropriate security measures were in place, and to confirm that vandalism, and not negligence, caused the incident.

### Method/Kit for Securing a Wellhead

An embodiment of a method for securing a wellhead includes providing the above-described devices to a user desirous of securing equipment at a wellhead. The user may remove certain types of wellhead equipment from the wellhead prior to securing the remaining wellhead equipment. For example, the user may choose to remove a pressure gauge, valve, or other device from the wellhead to visually deter scouts or vandals from approaching the wellhead.

The user then inserts threaded bull plug shields, each bearing a cable guide, into each empty port, if present; covers any pressure gauges or other devices remaining at the wellhead with additional device shields as desired; and wraps or threads one or more lengths of cable around the wellhead equipment, minimizing slack in the cable. The cable(s) may be cut to an appropriate length and/or enlarged portions added to the cable as appropriate. Restraints are closed around the cable in at least one location to secure the cable tightly against the equipment. Padlocks are then applied to the restraint(s) and device shield(s).

It should be noted that the present system of locking equipment at a wellhead provides a significant degree of flexibility. For example, if each device shield and cable restraint is locked with a separate padlock, selective access to each piece of wellhead equipment may be provided to specific individuals simply by providing these individuals with an appropriate set of keys.

Notably, several security devices as described above may each be individually secured against one wellhead using one or more cables 10, restraints 20, pressure gauge shields 80, and/or bull plug shields 70. A customized access system may therefore be implemented, in which the site engineer has a master key to lock up the entire wellhead, while flow testers may be given a key which only opens the padlock securing the access door of the pressure gauge.

If only one cable 10 is used to secure several device shields and/or valve wheels, several cable restraints may be used to individually secure each piece of equipment. If necessary, each restraint may be keyed separately to customize access to each piece of equipment. Thus, the present system allows selective authorized access to confidential information by specific individuals, minimizing the risk of information theft.

It should be noted that although the present description refers to the use of padlocks to secure each device, many other locking mechanisms could be used to secure each device, including electronic keying, biometric verification, smartcards, or keypad access to each device.

In an embodiment of the invention, a kit is provided for securing wellhead equipment at a wellhead. The kit minimally includes length of cable 10, and a restraint 20. The kit may also include further lengths of cable, metal cylinders for clamping to the cable to form enlarged portions of the cable, additional restraints, padlocks, and one or more device shields. The kit may also include instructions for using the above items in securing wellhead equipment

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A system for securing wellhead equipment at a wellhead, the system comprising:
a length of cable for wrapping or threading through wellhead equipment;
a cable restraint including two opposing clamping members for reversibly clamping around the cable; and
a locking mechanism for locking the clamping members in a clamping position around the cable to secure the cable around the wellhead equipment.

2. The system as in claim 1 wherein the cable includes a series of enlarged regions along its length, and wherein the clamping members, when closed around the cable, prevent sliding of the cable past an enlarged portion of the cable.

3. The device as in claim 2 wherein the enlarged portions of the cable are formed by threading steel cylinders onto the cable and crimping the steel cylinders in place against the cable.

4. The device as in claim 1 wherein the cable is steel rope.

5. The system as in claim 1 wherein the opposing clamping members are hingedly connected to facilitate closing around the cable.

6. The system as in claim 1 wherein the locking system comprises a padlock for insertion through aligned apertures in the clamping members when the clamping members are closed around the cable.

7. The system as in claim 1, further comprising a device shield for limiting access to a wellhead device, the shield having a cable guide through which the cable may be threaded to secure the shield against the device.

8. The system as in claim 7 wherein the shield further includes a threaded portion for fastening into an open port on the wellhead to shield the port, and wherein removal of the threaded portion from the port may be prevented by securing the shield with the cable.

9. The system as in claim 7, wherein the device shield includes a housing for placement over the device to obscure the device when the shield is secured with the cable against the device.

10. The system as in claim 9 wherein the device is a pressure gauge, and wherein the housing is slideable over the pressure gauge to obscure the gauge.

11. The system as in claim 9 wherein the housing includes a lockable access door through which the pressure gauge may be accessed without removing the device shield.

12. A method of securing wellhead equipment comprising the steps of:
providing a length of cable having a series of enlarged regions along its length;
wrapping the cable around the wellhead equipment;
providing a cable restraint formed from two opposing clamping members, the clamping members for closing around a length of the cable, and a locking system for locking the clamping members in a closed position;
closing the restraint around the cable proximal to an enlarged portion of the cable so as to prevent loosening of the cable from the wellhead equipment; and
locking the restraint in closed position.

13. The method as in claim 12 further comprising the steps of:
providing a shield for engaging a wellhead device, the shield having a cable guide through which a length of cable may be threaded;
engaging the wellhead device with the shield; and
threading the cable through the cable guide in the shield prior to securing the cable with the restraint around the wellhead.

14. The method as in claim 13 wherein the shield includes a threaded portion and wherein the shield is fastened into a wellhead port and secured with the cable to prevent removal of the shield from the port.

15. The method as in claim 13 wherein the shield includes a housing for shielding a pressure gauge to prevent unauthorized individuals from viewing the pressure gauge.

16. A kit for use in securing wellhead equipment, the kit comprising:
a length of flexible cable for wrapping around wellhead equipment;
a cable restraint for closing around the cable to secure the cable against the wellhead equipment; and
a locking system for use in locking the restraint around the cable to secure the cable against the wellhead equipment, thereby preventing removal of the equipment from the wellhead.

17. The kit as in claim 16 further comprising two or more steel cylinders for affixing to the cable to enlarge the diameter of the cable at two or more locations adjacent the cable restraint to prevent loosening of the cable from the wellhead equipment.

18. The kit as in claim 16 further comprising one or more device shields for engaging a wellhead device, each shield having a cable guide such that the device shields may be secured to the wellhead device with the cable and restraint.
